(19) United States
(12) Patent Application Publication
(10) Pub. No.: US 2011/0142385 A1
(43) Pub. Date: Jun. 16, 2011

(54) SEALING ELEMENT FOR SEALING A ROLLING BEARING, ROLLING BEARING AND METHOD FOR MOUNTING THE SEALING ELEMENT

(75) Inventor: Karl Keller, Hilchenbach (DE)

(73) Assignee: SMS SIEMAG AKTIENGESELLSCHAFT, Dusseldorf (DE)

(21) Appl. No.: 13/058,041

(22) PCT Filed: Aug. 5, 2009
(86) PCT No.: PCT/EP09/05661

§ 371 Date: Feb. 18, 2011

(30) Foreign Application Priority Data
Aug. 8, 2008 (DE) 10 2008 038 997.8

(51) Int. Cl. F16J 15/32; B21D 53/10

(52) U.S. Cl. 384/147; 29/898.04

(57) ABSTRACT

The invention relates to a sealing element (3) for sealing a rolling bearing with respect to a rolling journal (2) of a roller (1), wherein the sealing element (3) comprises: —a first part (10) located away from the rolling journal in a peripheral groove (9) in the rolling bearing; and—a second part (11) located close to the rolling journal in the form of a sealing lip, abutting to the rolling journal; characterized by a part (10.5) located on the sealing side of a latching device for latching the part (10) of the sealing element located away from the rolling journal (2) to a part (9.5) on the rolling journal side of the latching device in the peripheral groove (9). The invention further relates to a rolling bearing and to a method for mounting the sealing element (3) in the rolling bearing.

The invention relates to a sealing element for sealing a roll bearing relative to a roll neck of a roll, wherein the sealing element comprises:
a first roll part remote from the roll neck in a circumferential groove in the roll bearing;
a second part near the roll neck in the form of a sealing lip which rest against the roll neck.

The invention further relates to a roll bearing and a method for mounting the sealing element.

A sealing device for roll necks is known from DE 101 13 593 A1, wherein a neck bushing with a neck bushing extension are nonrotatably arranged relative to each other on the roll neck of a roll. The neck bushing extension is constructed with a sealing element which closes the gap between the neck sleeve extension and the surface of the transition area between roll neck and roll. This prevents the penetration of foreign bodies, for example, cooling agent or roll sinter, and a discharge of oil of the lubrication system as well as any existing abrasion from wear between the roll neck or the roll bevel and the neck bushing. The illustrated sealing element has a circular cross section and is arranged in a groove which is arranged circumferentially on the neck bushing extension.

A similar construction is known from DE 101 13 869 A1.

In an informational brochure with the title “MORGOIL® Roll Neck Bearings” and in a “Newsletter SMS metallurgy”, published each by the company SMS Demag, a sealing device is disclosed in which the sealing element has a rectangular contour and is arranged in a corresponding groove in the neck bushing extension. The gap between the neck bushing extension and the transition area is closed by the sealing lip extending from the rectangular contour of the sealing element.

In the assembly and disassembly of the roll bearing, especially when pushing and pulling the neck bushing with the neck bushing extension fastened thereto from the roll neck, the position of the sealing element can be changed. The sealing element manufactured, for example, of rubber, may adhere with its sealing lip to the surface of the transition area and be pulled as a result from the circumferential groove of the neck bushing extension. Pulling of the sealing element can take place either on the entire circumference—when the sealing lip adheres—as well as in a small area if the neck bushing has no circumferential gap when being pushed on or pulled off, but rather makes contact over a certain area. In this area, the sealing element is clamped and pulled out of the groove.

Therefore it is the object of the invention to provide a sealing element which remains stationary in the groove but can be easily exchanged.

In accordance with the invention, this object is met by a part of a locking device near the seal for locking the first part remote from the roll with a part of the locking device in the circumferential groove on the side of the roll bearing.

As a result of this configuration of groove and first part remote from the roll neck of the sealing element, a positively engaging connection is achieved without using additional holding elements. The sealing element is engaged or clicked into the groove, so that a better hold/a stationary anchoring of the sealing elements in the circumferential groove is achieved.

A preferred configuration provides that the locking device is composed of a raised portion and an indented portion which are in engagement with each other. Such a configuration makes it possible that the raised portion and the indented portion are adapted to each other precisely in the manner of lock and key.

A particular configuration provides that the raised portion is raised at the side close to the roll and/or on the side remote from the roll and the indented portion is formed in the side remote from the roll or the side of the groove close to the roll. By arranging the locking device at these locations, a particularly quick and simple placement and locking are achieved at these locations as well as a simple and quick release and removal, so that the elasticity of the sealing element is influenced over the width thereof.

In a further development of this manner of construction it is proposed that the indentation is constructed as an annular groove and/or the raised portion as an annular bead. Such a configuration simplifies the mounting and dismounting, because a uniform transition is present. The mounting and locking of the sealing element is particularly simplified by the provision of an inwardly directed conically shaped outlet at the annular bead.

Another simplification is additionally achieved by providing at the sidewall of the groove a raised portion which has the same shape and the same dimension as the indentation of the first part of the sealing element remote from the roll neck.

The first part remote from the roll neck and the second part close to the roll neck of the sealing element are constructed each as a single piece. However, this does not mean that it is not possible that different materials are used for clamping in the groove and the sealing lips.

In accordance with another configuration it is proposed that the roll bearing includes a neck bushing and a neck bushing extension fastened thereto and that the circumferential groove is formed in the neck bushing extension. By the configuration of the roll bearing into two structural parts, it is made possible that only in one of the separate components, particularly the neck bushing extension, the groove is introduced. With a change of the manner in which the groove is to be changed, it is then only necessary to replace the neck bushing extension. On the other hand, when the bearing bushing is to be exchanged, the bearing bushing extension with the groove does not have to be renewed.

The above object is further met by the roll bearing according to claim 9. This roll bearing is characterized by a part of a locking device on the side of the roll bearing in the circumferential groove for locking with a part of the locking device on the side of the seal in the part of the sealing element remote from the roll neck.

The above object is further met by a method for mounting a sealing element in a roll bearing, with the steps: 1) placing the sealing element in a circumferential groove of the roll bearing and 2) locking of the sealing element in the circumferential groove.

The advantages of the claimed roll bearing and the claimed method correspond to the advantages mentioned above in relation to the sealing element. In particular, the claimed solutions provide a better support or stationary anchoring of the sealing element in the groove of the roll bearing.

Further advantageous configurations of the sealing element, the roll bearing and the method are subject matter of the dependent claims.

Attached to the specification are two Figures, wherein

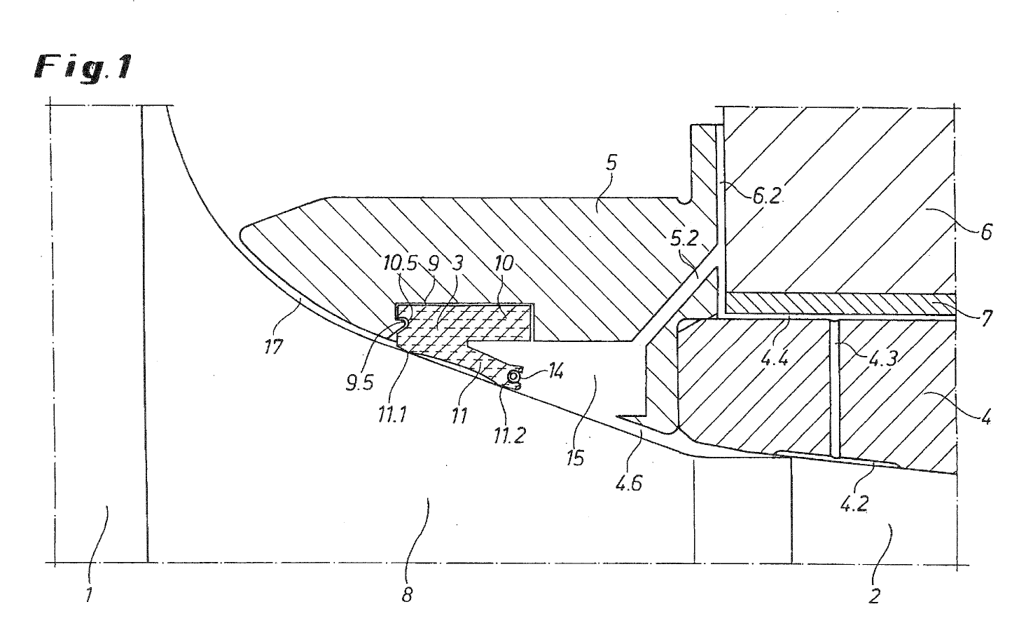

FIG. 1 shows a cross section through a roll bearing with a sealing element according to the present invention pushed onto the neck of a roll;

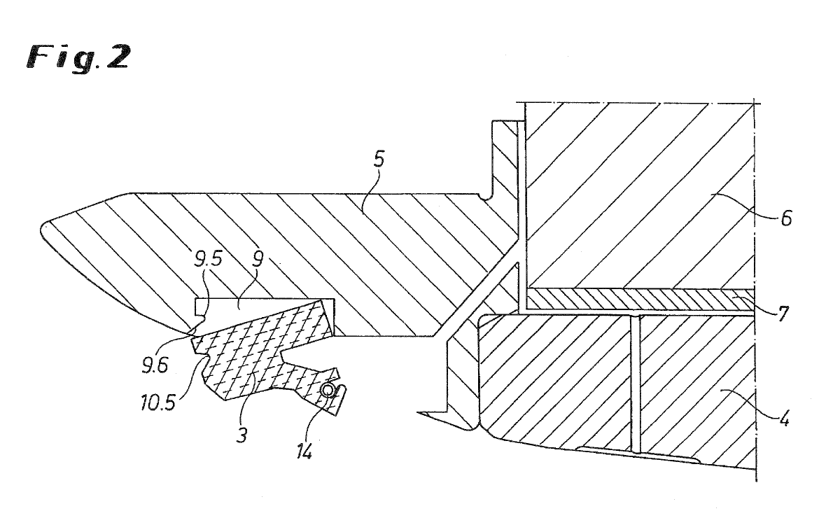

FIG. 2 shows a cross section through a roll bearing with the sealing element according to the invention after a first assembly step.

FIG. 1 shows a cross section through a roll 1 with a roll neck 2. Pushed onto the roll neck 2 is a sealing element 3 in connection with a neck bushing 4 and a neck bushing extension 5 which are non-rotatably mounted on the roll neck 2. The roll neck 2 with the bearing bushing 4 non-rotatably mounted on the neck 2 is rotatably supported in a bearing housing 6 with bearing bushing 7. Between the neck bushing 4 which rotates relative to the bearing bushing 7 and the bearing bushing is formed an oil film in the gap 4.4. Such a support is typically utilized in a roll stand (not illustrated) wherein the roll is used for rolling steel and non-iron metals.

In the assembled state the sealing element 3 is positioned between the neck bushing extension 5 and the roll neck 2 or the transition area 8 which extends between the roll 1 and the roll neck 2. The sealing element is typically constructed with an annular shape and is in the assembled state preferably pressed by the annular spring 14 onto the neck 2 or the transition area 8. For receiving the sealing element 3, the neck bushing extension 5 is constructed with a groove 9. Engaged in the groove 9 is a first part 10 of the sealing element 3 remote from the roll neck, while a second part 11 of the sealing element 3 near the roll neck, which is formed, for example, with one or two sealing lips 11.1, 11.2., rests against the roll neck. The first part 10 of the sealing element 3 remote from the roll neck has in the cross section the shape of a rectangle. The groove 9 is formed adapted to this shape and the corresponding dimensions.

The necessary oil film between the bearing bushing 7 and the neck bushing 4 in the gap 4.4 is fed (not visible in FIG. 1) from an oil supply to the frictional bearing. The oil pockets 4.2 are fed through the bores 4.3 because the oil pressure in the gap 4.4 is greater than in the pockets 4.2. Oil diffuses from the oil pocket 4.2 during the operation of the roll bearing in the annular space 15. The oil can flow off radially from there through the ducts 5.2 and 6.2.

The sealing element 3 serves for sealing the annular space 15 relative to a ring gap 17. In particular, the sealing element 3 and its part 11 near the roll neck prevent oil from diffusing from the annular space 15 into the annular gap 17.

The assembly of the sealing element 3 into the roll bearing, in principle, is divided into two steps:

1) Placement of the sealing element in a circumferential groove 9 of the roll bearing; see FIGS. 2; and 2) locking of the sealing element 3 in the circumferential groove 9.

In the step 1) initially the sealing element is only used at one location of the circumferential groove 9, particularly in the neck bushing extension. In the following, in step 2), the sealing element 3 is locked at this one location, preferably by pressing it in by hand. Subsequently, sections of the sealing element 3 are locked into the groove from this location, preferably toward both sides along the circumference continuously more and more sections of the sealing element 3 are engaged in the groove until finally the entire sealing element is engaged along the entire circumferential groove.

1-11. (canceled)

12. A roll bearing for receiving a roll neck of a roll, wherein the roll bearing comprises:
a circumferential groove; and
a sealing element for sealing the roll bearing relative to roll neck, wherein the sealing element has a first part remote from the roll neck in the circumferential groove of the roll bearing and a second part near the roll neck with at least one sealing lip which rests against the roll neck;
a locking device with a first part on a side of the roll bearing in the circumferential groove and with a second, seal-side part on in the first part of the sealing element remote from the roll neck for locking the first part of the sealing element with the first part of the locking device in the circumferential groove.

13. The roll bearing according to claim 12, wherein the first part of the locking device is formed on a side of the groove remote from and/or near the roll, and the second part of the locking device is formed on a side of the first part of the sealing element near the roll and/or remote from the roll.

14. The roll bearing according to claim 12, wherein the second part of the locking device is composed of a raised portion and the first part of the locking device is composed of an indentation, wherein the first part and the second part are in engagement with each other.

15. The roll bearing according to claim 14, wherein the indentation is formed as annular groove.

16. The roll bearing according to claim 14, wherein the raised portion is constructed as an annular bead.

17. The roll bearing according to claim 16, wherein the annular bead is formed inwardly with a conical end.

18. The roll bearing according to claim 12, wherein the first part of the locking device is composed of a raised portion and the second part of the locking device is composed of an indentation, wherein the first part and the second part are in engagement with each other.

19. The roll bearing according to claim 18, wherein the indentation is formed as annular groove.

20. The roll bearing according to claim 18, wherein the raised portion is constructed as an annular bead.

21. The roll bearing according to claim 20, wherein the annular bead is formed inwardly with a conical end.

22. The roll bearing according to claim 12, wherein the roll bearing is a neck bushing and a neck bushing extension attached thereto, the circumferential groove being formed in the neck bushing extension.

23. The roll bearing according to claim 12, wherein the first part of the sealing element remote from the roll neck and the second part of the sealing element near the roll neck are constructed as single pieces.

24. The roll bearing according to claim 12, wherein the first part of the sealing element remote from the roll neck and the second part of the sealing element near the roll neck are of different materials.

25. A method for mounting a roll bearing with a sealing element according to claim 12, comprising the steps of:
placing the sealing element in a circumferential groove of the roll bearing; and
locking the sealing element in the circumferential groove.

26. The method according to claim 25, wherein in the placing step the sealing element is initially used only at one location of the circumferential groove in the roll bearing, subsequently in the locking step the sealing element is locked at this one location, and further subsequently, from this location, continuously along the circumference, increasingly more sections of the sealing element are locked in the groove, until finally the entire sealing element is locked along the entire circumferential groove.

27. The method according to claim 26, wherein the one location of the circumferential groove is in the neck bushing extension of the roll bearing.

28. The method according to claim 26, wherein the sealing element is locked in the groove proceeding from both sides of the one location.
